(19) United States
(12) Patent Application Publication
(10) Pub. No.: US 2018/0182541 A1
(43) Pub. Date: Jun. 28, 2018

(54) WOUND-CORE PRODUCTION METHOD AND WOUND-CORE PRODUCTION APPARATUS

(71) Applicant: Toshiba Industrial Products and Systems Corp., Kawasaki-shi, Kanagawa (JP)

(72) Inventors: HIROMU SHIOTA, Mie-gun, Mie (JP); YOSHINORI YAMAZAKI, Mie-gun, Mie (JP); TSUYOSHI MASUDA, Mie-gun, Mie (JP); EIJI SHIMOMURA, Mie-gun, Mie (JP); YUJI ISHIKAWA, Mie-gun, Mie (JP)

(73) Assignee: Toshiba Industrial Products and Systems Corp., Kawasaki-shi, Kanagawa (JP)

(21) Appl. No.: 15/759,439

(22) PCT Filed: Feb. 9, 2016
(86) PCT No.: PCT/JP2016/053807

§ 371 Date: Mar. 12, 2018

(30) Foreign Application Priority Data
Sep. 10, 2015 (JP) 2015-178484

(51) Int. Cl. H01F 41/02; H01F 27/30; H01F 27/34

(52) U.S. Cl. CPC H01F 41/0233; H01F 27/341; H01F 27/306

(57) ABSTRACT

The present embodiment provides a wound-core production method for winding and laminating a plurality of pieces of core material which has at least one cut in each winding and thereby producing a wound core having a rectangular aperture in a central part, the wound-core production method comprising laminating the plurality of pieces of the cut core material while winding the core material into a shape of a rectangular frame using a winding device.

### TECHNICAL FIELD

An embodiment of the present invention relates to a wound-core production method and a wound-core production apparatus.

### BACKGROUND ART

Recent years, for example, as a big technical trend in small distribution transformers, energy saving and efficiency improvement have been strongly promoted as exemplified by application of the so-called Top Runner Program in Japan and establishment of standards for greater efficiency improvement on a global basis. Among other things, efforts to reduce so-called “core loss,” i.e., no-load loss, which is power loss occurring in an iron core, are being made on a global scale and manufacturers are competing fiercely in an effort to improve core materials and core structures. Here, a laminated core created by laminating cut thin silicon steel sheets and a wound core created by winding cut thin silicon steel sheets are known as transformer cores. The wound core, in which magnetic flux flow in the iron core is less prone to getting obstructed, is advantageous over the laminated core from the viewpoint of core loss reduction.

For example, Patent Literature 1 discloses an example of a production method for such a wound core. Generally, this type of wound core is produced by a method such as described below. That is, while being cut turn by turn into individual windings from a thin silicon steel sheet, core material is laminated by being wound around a circular winding form. Subsequently, the wound core material annular in shape is pressed with forming dies applied to inner and outer sides of the core material, and consequently formed into the shape of a rectangular frame having an approximately rectangular aperture provided in a center. In so doing, bending stress which causes increases in core loss is produced in the core material of the wound core. Therefore, a treatment intended to relieve residual stress and restore core loss characteristics is carried out, i.e., an annealing treatment which involves heating the wound core, for example, to approximately 800 degrees C. and then cooling the wound core slowly is carried out. In addition to restoring core loss characteristics, the annealing also serves the purpose of preserving the shape of the pressed core material. Also, in assembling windings on the wound core, the wound core is opened once in a cut in each piece of the core material, and then the wound core is closed again after the windings are assembled around linear portions (legs) of the wound core.

### CITATION LIST

### Patent Literature

Patent Literature 1: Japanese Patent Publication No. 5-159953

### SUMMARY OF INVENTION

### Technical Problem

The wound-core production method described above involves winding the core material cut into individual windings around a circular winding form once, thereby forming the annular core material, and subsequently press-forming the annular core material into the shape of a rectangular frame. This involves a two-stage assembly process, making it difficult to build a continuous production line, and consequently a buffer for an intermediate product is provided in each process, resulting in increased inventories. Also, the production method requires the “winding form” used to wind the core material into an annular shape and the “forming die” used to press-form the core material into the shape of a rectangular frame, resulting in the need for production management for the purpose of storing a large number of dies/forms and supplying the dies/forms to production processes.

Thus, the present embodiment provides a wound-core production method and a wound-core production apparatus, where the production method can eliminate the conventionally required buffers for intermediate products by eliminating the need to press-form annular core material into the shape of a rectangular frame, ease production management by eliminating the need for a winding form and forming die, and thereby improve manufacturability.

### Solution to Problem

The present embodiment provides a wound-core production method for winding and laminating a plurality of pieces of core material which has at least one cut in each winding and thereby producing a wound core having a rectangular aperture in a central part, the wound-core production method comprising laminating the plurality of pieces of the cut core material while winding the core material into a shape of a rectangular frame using a winding device.

Also, the present embodiment provides a wound-core production apparatus which winds and laminates a plurality of pieces of core material having at least one cut in each winding and produces a wound core having a rectangular aperture in a central part, the wound-core production apparatus comprising: a cutting device adapted to cut the core material; and a winding device adapted to laminate the plurality of pieces of the core material cut by the cutting device, while winding the core material into a shape of a rectangular frame.

### BRIEF DESCRIPTION OF DRAWINGS

FIG. 1 is a block diagram showing a schematic configuration of a wound-core production apparatus according to an embodiment of the present invention.

FIG. 2 is an enlarged view showing how core material is wound.

FIG. 3 is a perspective view schematically showing how a wound core wound into the shape of a rectangular frame is bound by a binding member.

FIG. 4 is a diagram corresponding to FIG. 3 and showing another form of binding a wound core with a binding member.

FIG. 5 is a diagram corresponding to FIG. 3 and showing a form in which a wound core has a different shape.

### DESCRIPTION OF EMBODIMENT

An embodiment of a wound-core production method and wound-core production apparatus will be described below with reference to the drawings.

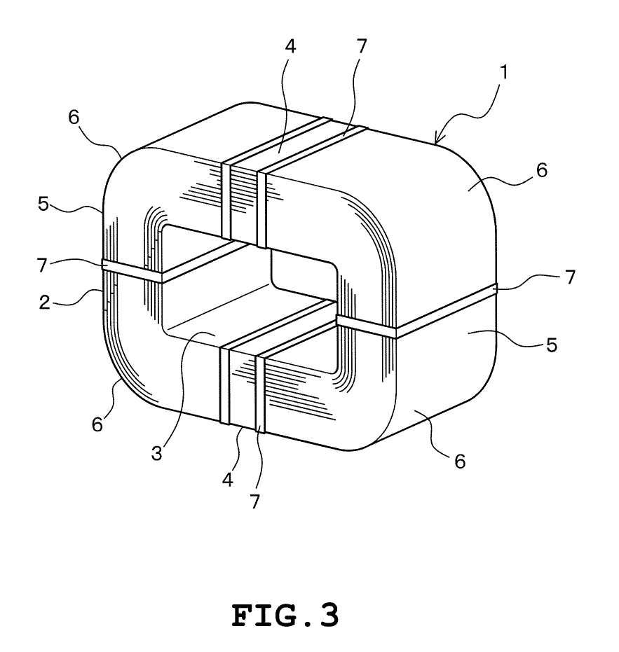

First a wound core 1 shown in FIG. 3 has a configuration in which a plurality of pieces of core material 2 obtained by cutting a silicon steel sheet are wound and laminated as described later and has the shape of an approximately rectangular frame as a whole with an approximately rectangular aperture 3 provided in a central part. Around the aperture 3, the wound core 1 includes a pair of long-side portions 4 opposed to each other, each forming a linear shape, a pair of short-side portions 5 opposed to each other, each forming a linear shape a little shorter than the long-side portions 4, and corner portions 6 provided at four corners. In this case, each of the corner portions 6 is shaped as a curved surface (arc). In the wound core 1 shown in FIG. 3, binding members 7 are tied around each of the long-side portions 4 and short-side portions 5. The binding members 7 are constructed, for example, from steel bands made of material having heat resistance, and are each wound around the wound core 1 by passing through the aperture 3 once.

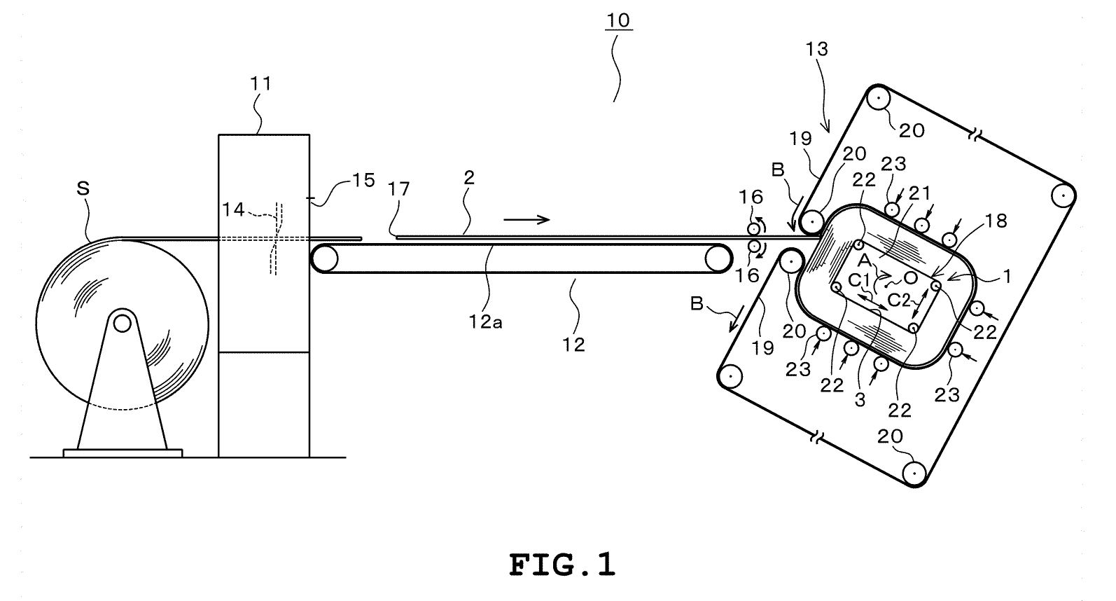

A schematic configuration of a production apparatus 10 which produces the wound core 1 is shown in FIG. 1. The production apparatus 10 includes a cutting device 11, a conveying unit 12, and a winding device 13. The cutting device 11 pulls out core material from a silicon steel sheet S wound into the shape of a coil and cut the core material to required length using cutting means 14. From an exit 15 of the cutting device 11, the core material 2 cut into individual windings is sent out in sequence toward the conveying unit 12. The conveying unit 12 is made up, for example, of a belt conveyor and conveys the core material 2 sent out from the exit 15, toward the winding device 13 using a belt 12a. The core material 2, which has cuts 17 at opposite ends, is conveyed on the belt 12a and then supplied to the winding device 13 by pinch rollers 16.

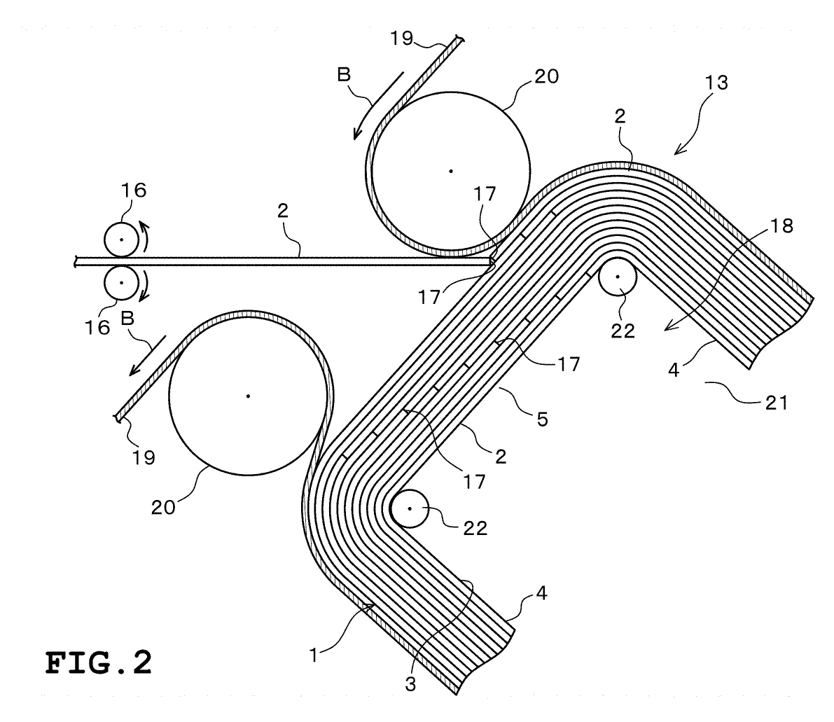

The winding device 13 includes a winding core 18, a belt 19 functioning as pressing means, and a plurality of guide rollers 20 adapted to guide movement of the belt 19. The winding core 18 includes a base 21 rotated around a rotation center O and four rollers 22 installed on the base 21. As the winding core 18 rotates around the rotation center O in the direction of arrow A in FIG. 1, the core material 2 is wound around the four rollers 22 and laminated in sequence. As shown in FIG. 2, the cuts 17 in the core material 2 is located in one of the short-side portions 5 of the wound core 1 in such a way as to be able to be shifted in position.

In the winding device 13, the belt 19 is placed, surrounding outermost core material 2, and moves in the direction of arrow B in synchronization with the rotation of the winding core 18 while pressing the core material 2 being wound around the winding core 18, in a direction of the winding core 18, i.e., inward in a lamination direction, from outside. Also, rotational motion of the winding core 18 is synchronized with cutting motion of the cutting device 11, and the core material 2 sent out from the cutting device 11 is wound by the winding device 13 in sequence. As a predetermined number of pieces of core material 2 are wound around the winding core 18 in this way and laminated, the wound core 1 in the shape of a rectangular frame is formed. Note that if it is difficult to form the core material into the shape of a rectangular frame due to increases in rigidity during forming depending on thickness of the core material, a plurality of pressing rollers 23 can be placed on an outer circumference of the belt 19 and used to press the core material 2, making the forming easier.

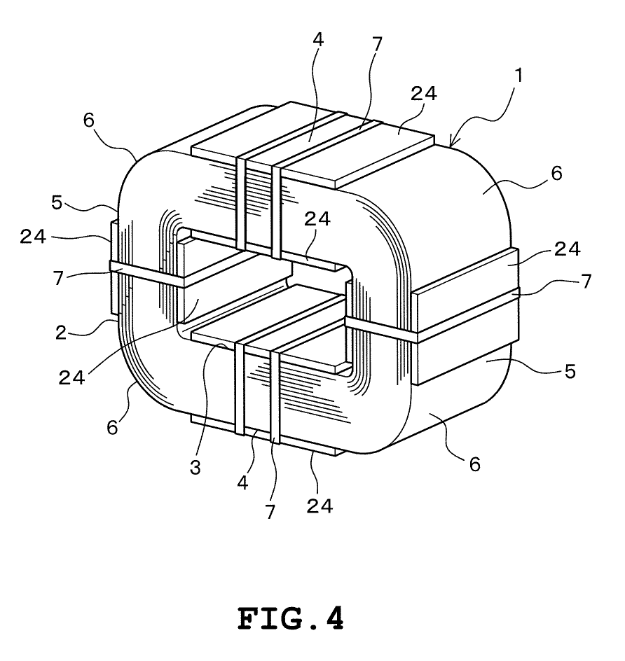

When the winding of the core material 2 is completed, the wound core 1 is bound by the binding members 7 in a plurality of locations (see FIG. 3). In so doing, as shown in FIG. 3, in the long-side portions 4 and short-side portions 5 of the wound core 1, the binding members 7 are each bound around the wound core 1 by passing through the aperture 3, thereby preventing the wound core material 2 from losing its shape. In a state of being bound by the binding members 7 in this way, the wound core 1 is removed from the winding device 13. If the core material has increased rigidity during forming as described above, deformation tending to restore the original state after forming can be inhibited by additionally inserting plate-shaped auxiliary material 24 between the wound core 1 and binding members 7 as shown in FIG. 4.

In the winding device 13, the four rollers 22 of the winding core 18 forms the rectangular aperture 3 of the wound core 1. In this case, the four rollers 22 are configured to be movable in a longitudinal direction (see arrow C1 in FIG. 1) of the aperture 3 and a lateral direction (see C2 in FIG. 1) orthogonal to the longitudinal direction and are configured to allow dimensions (sizes) of the aperture 3 to be changed by adjusting positions of the four rollers 22.

Then, the wound core 1 removed from the winding device 13 undergoes an annealing treatment in a state of being bound by the binding members 7. In the annealing treatment, the wound core 1 is heated to approximately 800 degrees C., and then cooled slowly. In assembling non-illustrated windings on the wound core 1 produced in this way, the wound core 1 is opened once in the cut 17 in each piece of the core material, and then the wound core 1 is closed again after the windings are assembled around the long-side portions 4 of the wound core 1.

In the embodiment described above, the plurality of pieces of the core material 2 cut as individual windings are laminated while being wound into the shape of a rectangular frame by the winding device 13, thereby producing the wound core 1 having the rectangular aperture 3 in the central part. Whereas the conventional production method involves winding core material cut into individual windings around a circular winding form once, thereby forming annular core material, and subsequently press-forming the annular core material into the shape of a rectangular frame, the present embodiment eliminates the need to press-form the annular core material into the shape of a rectangular frame, making it possible to improve manufacturability. Also, there is no need for a winding form used to wind the core material into an annular shape.

A cutting process of the cutting device 11 adapted to cut the core material 2 and a winding process of the winding device 13 adapted to wind the cut core material 2 are continuous with each other, making it possible to further improve the manufacturability of the wound core 1.

Since the winding device 13 includes the belt 19 as the pressing means for pressing the core material 2 wound around the winding core 18 in the lamination direction, the core material 2 can be wound properly around the winding core 18. Also, since the belt 19 is configured to move in synchronization with the rotation of the winding core 18, the core material 2 can be wound more properly around the winding core 18.

By synchronizing the rotational motion of the winding core 18 on the winding device 13 with the cutting motion of the cutting device 11, it is possible to further improve the manufacturability of the wound core 1.

Also, in any of the processes before the core material 2 is wound by the winding device 13, if a bending tendency is created by press-forming the core material 2 in such a way as to bend the core material 2, the core material 2 wound by the winding device 13 can be wound properly into the shape of a rectangular frame, making it possible to further prevent the wound core material 2 from losing its shape.

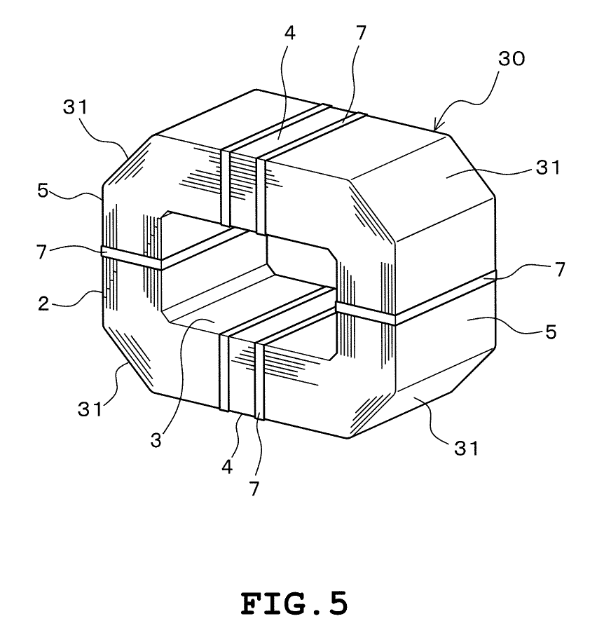

This is effective, for example, in producing a wound core 30 shaped as a rectangular frame such as shown in FIG. 5. With the wound core 1 described above, the corner portions 6 at the four corners are each shaped as a curved surface (arc). In contrast, with the wound core 30 shown in FIG. 5, corner portions 31 at four corners have a planar shape, obliquely connecting between the long-side portions 4 and short-side portions 5. In producing such a wound core 30 using the production method such as described above, in a process before the core material 2 is wound by the winding device 13, if a bending tendency is created by press-forming the core material 2 including the corner portions 31, the core material 2 can be wound properly into the shape of a rectangular frame, making it possible to further prevent the wound core material 2 from losing its shape.

The winding device 13 is configured such that the dimensions of the aperture 3 in the wound core 1 can be changed by changing the positions of the four rollers 22 of the winding core 18. This provides the advantage of being able to produce wound cores 1 differing in the dimensions of the aperture 3 using a single winding core 18.

The present embodiment has a process in which after a plurality of pieces of the core material 2 are wound into the shape of a rectangular frame by the winding device 13, the resulting wound core 1 is removed from the winding device 13 in a state of being bound by the binding members 7. Thus, by binding the wound core 1 with the binding members 7, since it is possible to keep the wound core 1 in shape, it is easy to remove the wound core 1 from the winding device 13 and the wound core 1 can easily be stored and conveyed to a next process after the removal. Since the binding members 7 has heat resistance, the annealing treatment of the wound core 1 can be carried out with the wound core 1 kept bound by the binding members 7.

### OTHER EMBODIMENTS

The pressing means for pressing the core material 2 wound around the winding core 18 toward the winding core 18 may be made up, for example, of a plurality of rollers instead of the belt 19.

As described above, in producing a wound core having a rectangular aperture in a central part by winding and laminating a plurality of pieces of core material which has at least one cut in each winding the present embodiment eliminates the need to press-form the annular core material into the shape of a rectangular frame, and improves manufacturability.

The present embodiment is presented only by way of example, and is not intended to limit the scope of the invention. The novel embodiment can be implemented in various other forms, and various omissions, replacements, and changes can be made without departing from the gist of the invention. The present embodiment and modifications thereof are included in the gist and scope of the invention as well as in the invention set forth in the appended claims and the scope of equivalents thereof.

1. A wound-core production method for winding and laminating a plurality of pieces of core material which has at least one cut in each winding and thereby producing a wound core having a rectangular aperture in a central part, the wound-core production method comprising
laminating the plurality of pieces of the cut core material while winding the core material into a shape of a rectangular frame using a winding device.

2. The wound-core production method according to claim 1, wherein a cutting process for cutting the core material and a winding process of the winding device are continuous with each other.

3. The wound-core production method according to claim 1, wherein the winding device includes pressing means for pressing the core material being wound, in a lamination direction.

4. The wound-core production method according to claim 3, wherein:
the winding device includes a winding core adapted to wind the core material; and
the pressing means is a belt adapted to move in synchronization with rotation of the winding core.

5. The wound-core production method according to claim 2, wherein:
the winding device includes a winding core adapted to wind the core material; and
rotational motion of the winding core in the winding process is synchronized with cutting motion in the cutting process.

6. The wound-core production method according to claim 1, wherein in any of processes before the core material is wound by the winding device, the core material is press-formed.

7. The wound-core production method according to claim 1, wherein:
the winding device includes a winding core adapted to wind the core material; and
the winding core is configured such that dimensions of the aperture can changed.

8. The wound-core production method according to claim 1, comprising a process in which after the core material is wound into the shape of a rectangular frame using the winding device, the resulting wound core 1 is removed from the winding device in a state of being bound by a binding member having heat resistance.

9. The wound-core production method according to claim 8, wherein the binding member is bound around the wound core by passing through the aperture of the wound core at least once.

10. The wound-core production method according to claim 8, wherein after being bound by the binding member, the wound core is annealed.

11. A wound-core production apparatus which winds and laminates a plurality of pieces of core material having at least one cut in each winding and produces a wound core having a rectangular aperture in a central part, the wound-core production apparatus comprising:
a cutting device adapted to cut the core material; and
a winding device adapted to laminate the plurality of pieces of the core material cut by the cutting device, while winding the core material into a shape of a rectangular frame.
